(19) United States
(12) Patent Application Publication
(10) Pub. No.: US 2013/0049473 A1
(43) Pub. Date: Feb. 28, 2013

(54) FLUID-DRIVEN FLYWHEEL UNINTERRUPTIBLE POWER SUPPLY

(71) Applicants: Brad L. Brech, Rochester, MN (US); Don A. Gilliland, Rochester, MN (US); Cary M. Huettner, Rochester, MN (US); Douglas A. Wood, Raleigh, NC (US); Dennis J. Wurth, Rochester, MN (US)

(72) Inventors: Brad L. Brech, Rochester, MN (US); Don A. Gilliland, Rochester, MN (US); Cary M. Huettner, Rochester, MN (US); Douglas A. Wood, Raleigh, NC (US); Dennis J. Wurth, Rochester, MN (US)

(73) Assignee: INTERNATIONAL BUSINESS MACHINES CORPORATION, Armonk, NY (US)

(21) Appl. No.: 13/215,915

(22) Filed: Aug. 23, 2011

(51) Int. Cl. H02J 9/06

(52) U.S. Cl. 307/68

(57) ABSTRACT

An Uninterruptible Power Supply (UPS) for providing power to a computer system. The UPS converts kinetic energy of cooling fluid already being pumped through the computer system to operate a reaction turbine. The turbine drives a flywheel, which in turn can drive a generator in the case of a power failure. A gravity feed may continue to supply cooling fluid to the system, at least for a time, after the power is lost. The turbine can continue to store this energy in the flywheel after power failure thereby extending the ride-through time available.

### FIELD OF INVENTION

This disclosure relates generally to the field of energy storage, and in particular, to energy storage in an uninterruptible power supply (UPS) for a system of computers.

### BACKGROUND

Data centers that host mission critical applications invest significant money in building redundant infrastructure. In the case of power distribution, a server or rack of servers may have redundant power supplies, each with their own distribution line from an independent utility.

Data centers invest this money because their services can be severely disrupted if their supply of electrical power is interrupted even for a few seconds. In addition to, or as an alternative to redundant power supplies, uninterruptible power supply (UPS) systems are in common use to prevent the disruption of operations when a normally used electric power line falters or fails. UPS systems typically have access to a local power generator (such as internal-combustion engines) to supply electrical power to the load until normal power is restored.

Often when utility power fails, it takes a few seconds for a back-up generator to start and accelerate to a speed fast enough to produce the desired electrical output. This delay may result in a harmful interruption of power to the load.

UPS systems typically use either battery power or a flywheel to overcome this delay. A flywheel is a rotating mechanical device used to store rotational energy. Energy is added to the flywheel by increasing its speed (through the application of torque). Typically flywheels are made of heavy materials to increase their moment of inertia, making the flywheel more resistant to change in rotational speed. In a flywheel UPS, during normal operation electrical power is used to spin the flywheel and keep the flywheel spinning at a high speed. Once a flywheel has reached a high speed, due to high moment of inertia, little energy is needed to keep up the speed of the flywheel. During a utility power outage, the flywheel catches gearing (such as a hydraulic transmission) to drive an alternator/generator, which in turn supplies electrical power to the load. The time that a flywheel can deliver power to a system is known as the “ride-through time.”

Increased work load and smaller parts in data centers also make them susceptible to higher temperatures. State of the art data centers may use liquid cooling technology, where a coolant (often water) is pumped through the various servers and/or racks to efficiently reduce the temperature build-up.

### SUMMARY

One aspect of the present invention discloses an uninterruptible power supply (UPS) for providing electrical power to one or more computers. The UPS comprises a turbine and an intake tube that is capable of channeling moving fluid to the turbine. An output tube is capable of channeling moving fluid from the turbine. The UPS further comprises a flywheel for driving a generator capable of providing electrical power to the one or more computers. A turbine shaft is coupled to the turbine and to the flywheel, the turbine shaft is capable of being driven by the turbine and of driving the flywheel.

A second aspect of the present invention discloses a system for providing power to one or more computers. The system comprises a generator coupled to the one or more computers. A flywheel is coupled to and capable of driving the generator. The system further comprises an uninterruptible power supply (UPS) comprising a fluid-driven turbine coupled to and capable of driving the flywheel. A server rack contains the UPS and at least one of the one or more computers. A liquid-cooling system couples to the UPS and is capable of pushing a fluid to the server rack and to the fluid-driven turbine of the UPS. The generator, when driven by the flywheel, is capable of providing electrical power to the one or more computers.

A third aspect of the present invention discloses a method for powering a computer. The method comprises an uninterruptible power supply (UPS) receiving a fluid. The UPS channels the fluid to a reaction turbine via an intake tube. The reaction turbine rotates a turbine shaft. The rotating turbine shaft drives a flywheel coupled to the rotating turbine shaft and a generator. In response to the computer losing electrical power, the flywheel drives the generator and the flywheel-driven generator supplies electrical power to the computer system.

### BRIEF DESCRIPTION OF THE SEVERAL VIEWS OF THE DRAWINGS

The following detailed description, given by way of example and not intended to limit the disclosure solely thereto, will best be appreciated in conjunction with the accompanying drawings, in which:

FIG. 1 depicts a server rack comprising a localized, water-driven flywheel UPS in accordance with an embodiment of the present invention.

FIG. 2 depicts water flow into the rack of FIG. 1 in accordance with an embodiment of the present invention.

FIG. 3 shows a more in depth view of components of an embodiment of the UPS of FIG. 1.

FIG. 4 illustrates a water turbine operational within the UPS of FIG. 1, without an outer-encasement, in accordance with an embodiment of the present invention.

FIG. 5 depicts the working of a Kaplan turbine in accordance with an embodiment of the invention.

FIG. 6 depicts an embodiment of a planetary gear.

### DETAILED DESCRIPTION

Detailed embodiments of the present invention are disclosed herein with reference to the accompanying drawings; however, it is to be understood that the disclosed embodiments are merely illustrative of potential embodiments of the invention and may take various forms. In addition, each of the examples given in connection with the various embodiments is also intended to be illustrative, and not restrictive. This description is intended to be interpreted merely as a representative basis for teaching one skilled in the art to variously employ the various aspects of the present disclosure. In the description, details of well-known features and techniques may be omitted to avoid unnecessarily obscuring the presented embodiments.

Embodiments of the invention provide a computer system utilizing one or more localized flywheel UPS systems, where the flywheel UPS systems use the kinetic energy of pumped coolant to drive a turbine, which in turn drives the flywheel. As an alternative to pumped coolant, a gravity feed may supply the coolant to the turbine subsequent to a power failure, thereby extending the ride-through time.

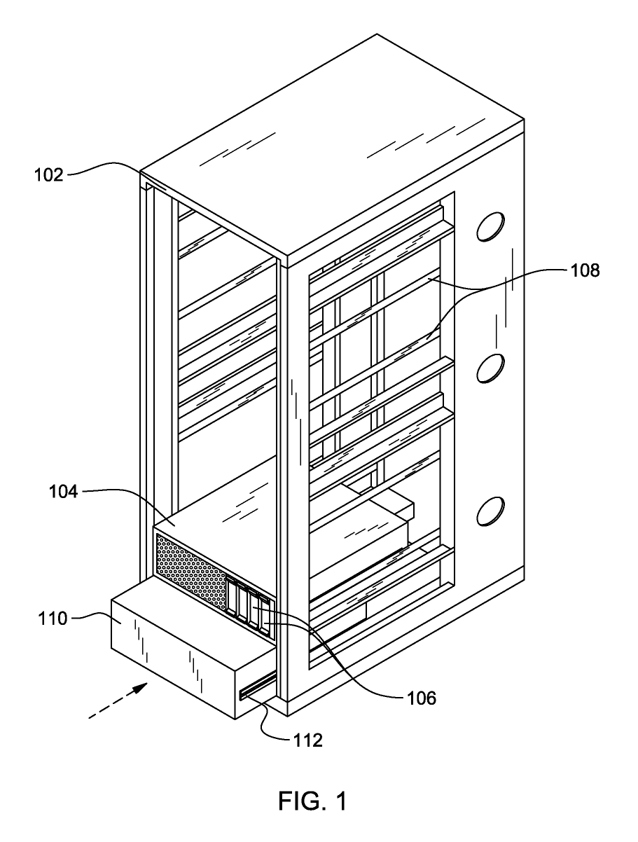

FIG. 1 depicts a server rack in which a localized, water-driven flywheel UPS may be implemented. Rack 102 is a server rack of a data center. Rack 102 may hold any number of rack-mountable units. A rack-mountable unit is any enclosure designed to fit in rack 102. In the depicted example, rack-mountable unit 104 is a server computer unit. In one embodiment, rack-mountable unit 104 holds Blade® servers 106. In another embodiment, rack-mountable unit 104 is a single server computer. The capability to expand a datacenter by only the server computers needed, and do so one rack at time, allows for an efficient use of space and resources. Every rack-mountable unit may connect to mounting bars 108.

Rack 102 is designed with rack-based real estate, which allows a local (rack-mountable) UPS, such as UPS 110, to be installed directly in the rack. Distributing UPS systems among the racks allows the UPS function to scale upwards with the size of the overall datacenter and to scale it proportionally with the additional servers. The sides of the enclosure for UPS 110 include mounting bars 112 to couple with one set of mounting bars 108 on rack 102. UPS 110 may slide into its designated space.

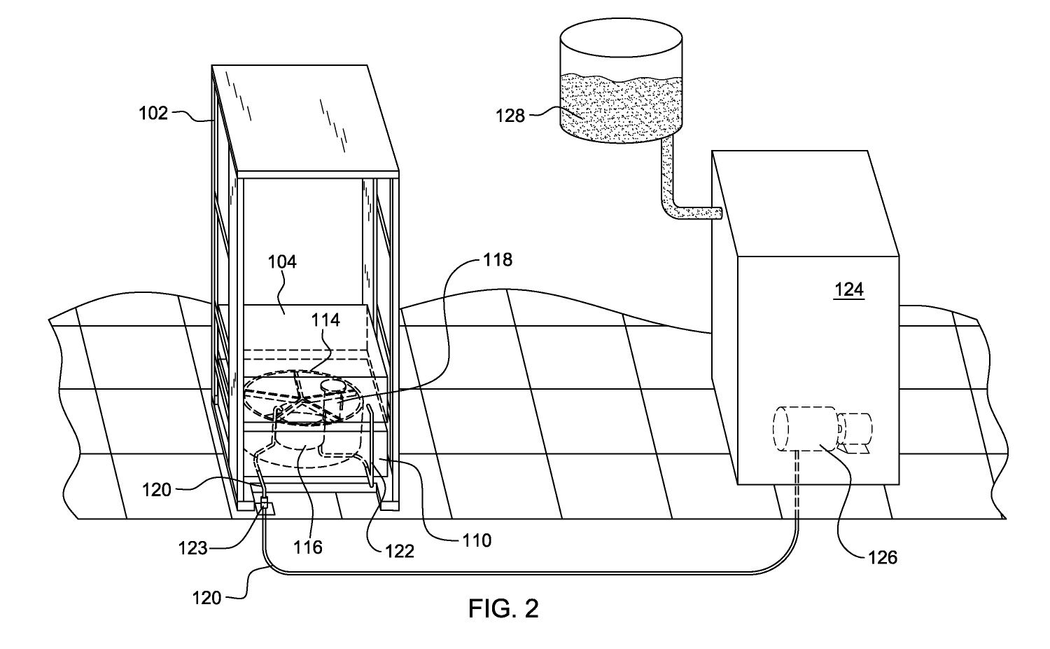

FIG. 2 depicts water flow into rack 102 in accordance with an embodiment of the present invention.

Rack 102 is depicted from a rear view. At the bottom of rack 102, UPS 110 has been installed. The enclosure of UPS 110 is shown opaque here to show an embodiment of a water-driven flywheel UPS. The water-driven flywheel UPS comprises flywheel 114, water turbine 116, and alternator 118. Water (or other coolant liquid) is supplied to water turbine 116 of UPS 110 via coolant piping 120. After passing through water turbine 116, the water is expelled through exit piping 122 which channels the water to server computer 104 to perform its normal cooling function.

In a second embodiment, water may run through one or more server computers prior to UPS 110. In a third embodiment, a separate piping line may exist for supplying water to server computers.

Coolant piping 120 connects to rack 102 through quick-connect terminal 123. Racks using liquid cooling typically already have such terminals to facilitate running water to them. Generally, existing quick-connect terminals are near the bottom of a rack, making a bottom slot a preferred location for UPS 110. Additionally, housing UPS 110 at the bottom of rack 102 avoids having moving mechanical parts with a high flow of water positioned above sensitive electronic equipment. Piping 120 is preferably a high pressure flex pipe.

Liquid cooling system 124 uses pump 126 to push the water through piping 120. In a preferred embodiment, liquid cooling system 124 also maintains a water reservoir 128. Reservoir 128 may be coupled to a pressure tank so that in a scenario where pump 126 gives out (e.g. for lack of electrical power), water can still be supplied to rack 102 for a short amount of time. Alternatively, reservoir 128 may be elevated to feed the water through liquid cooling system 124 through gravitational force in a scenario where pump 126 does not work. This embodiment may be preferred as the extended length of time for running water is determined by the amount of water stored in the reservoir and not an amount of pressure stored.

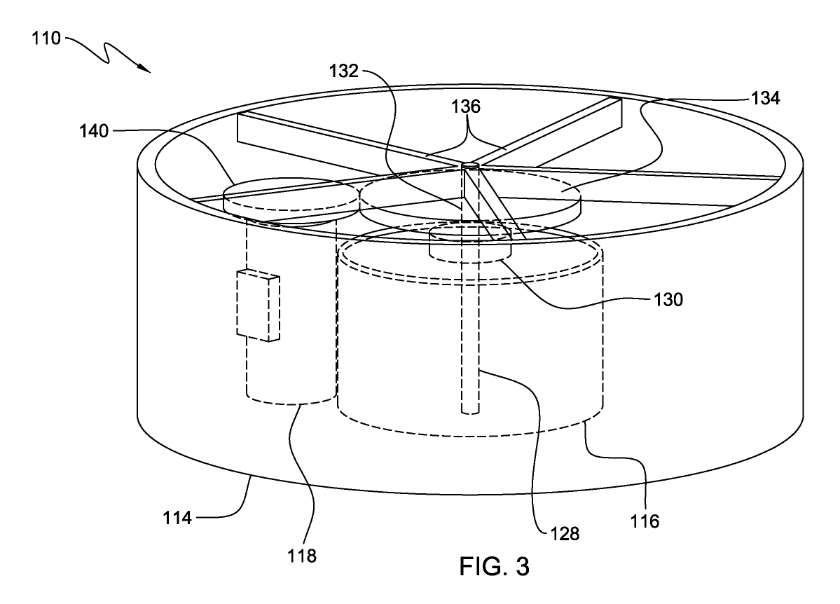

FIG. 3 shows a more in depth view of components of UPS 110.

As mentioned earlier, the central components to UPS 110 include flywheel 114, water turbine 116, and alternator 118.

Flywheel 114 is preferably a thick-walled empty cylinder oriented to spin horizontally. Using an empty cylinder, as opposed to a solid cylinder or disk, allows water turbine 116 to fit within the hollow of flywheel 114 and conserve space. The thick walls allow for flywheel 114 to have a greater mass and hence a greater moment of inertia. Additionally, the walls of the cylinder forming flywheel 114 will preferably extend as far out as the enclosure of UPS 110 will allow, keeping the mass as far away from the center of the cylinder as possible, also increasing the moment of inertia. The moment of inertia can be determined using the following equation, where I is the moment of inertia, m is the mass of flywheel 114 and r is the radius to either the outer wall or the inner wall of flywheel 114.

I=½m(rₑₓₜₑᵣₙₐₗ²+rᵢₙₜₑᵣₙₐₗ²)

Flywheel 114 is preferably composed of stainless steel or a ceramic. In addition to mass, these materials can be accurately balanced and lend to stability.

In an alternate embodiment, flywheel 114 may be any number of shapes.

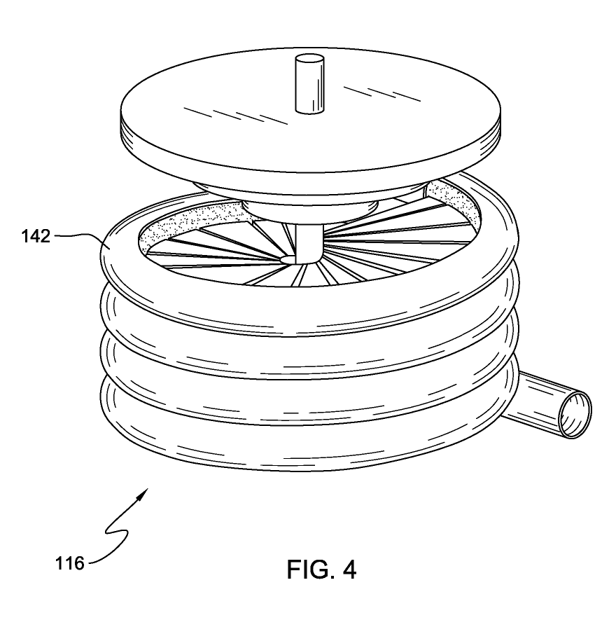

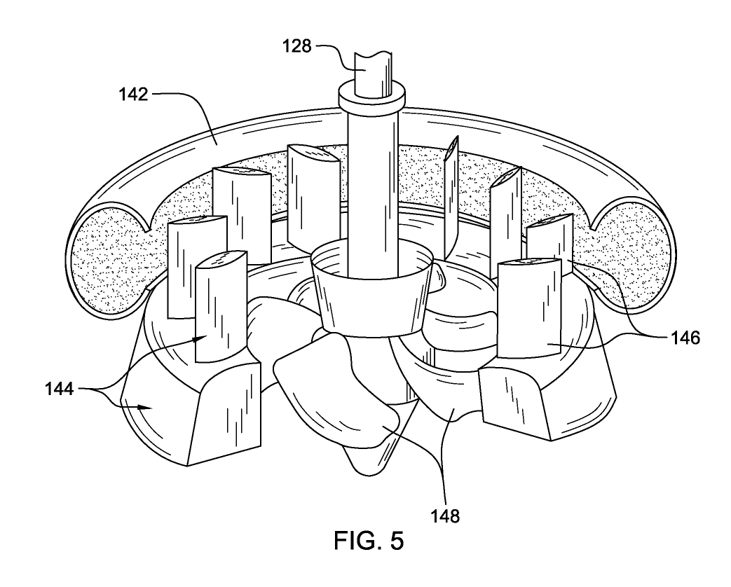

Water turbine 116 is preferably centered within the cylinder of flywheel 114. In a preferred embodiment, water turbine 116 is a reaction turbine. A reaction turbine is acted on by a liquid, which changes pressure as it moves through the turbine, releasing energy. To contain the water pressure, a reaction turbine should be encased. Operation of an exemplary embodiment of water turbine 116 is discussed further in FIGS. 4 and 5.

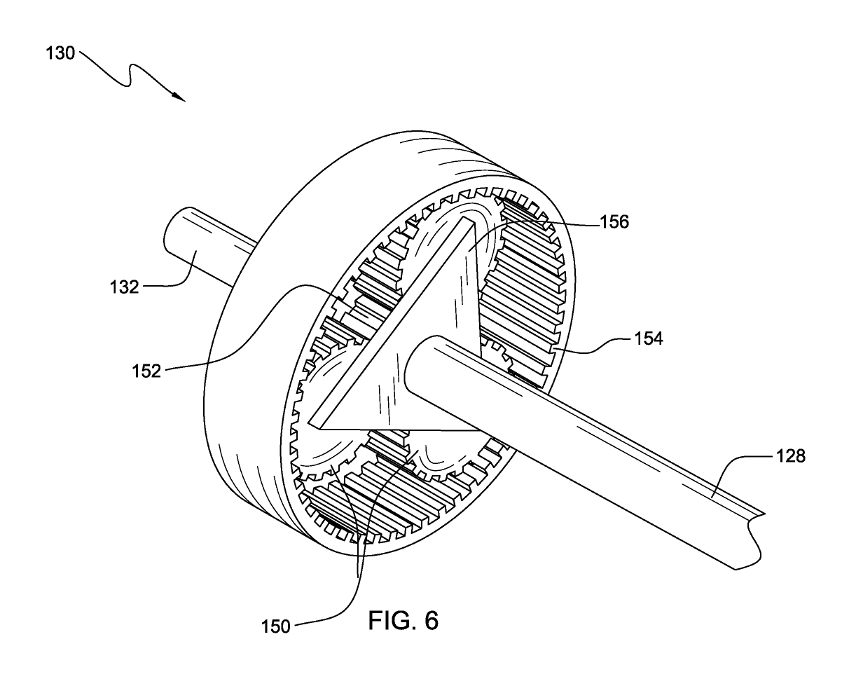

As water turbine 116 is driven by the flow of water, turbine shaft 128 rotates. Though the torque created by rotating turbine shaft 128 could be applied to flywheel 114 directly, to increase the speed, turbine shaft 128, preferably, drives planetary gear 130. Planetary gear 130 uses planetary, or epicyclic, gearing to manipulate gear ratios for a desired output of rotational velocity. An exemplary embodiment of planetary gear 130 is discussed in FIG. 6.

Planetary gear 130 relays its increased rotational velocity to output shaft 132, which in turn drives flywheel 114. Output shaft 132 attaches to drive gears 134 which apply torque to flywheel support arms 136. Flywheel support arms 136 attach directly to flywheel 114, transferring the torque to flywheel 114. In one embodiment, flywheel support arms 136 and flywheel 114 may be cast together. In another embodiment, flywheel support arms 136 may be a separate structure than flywheel 114 and be adhesively or mechanically attached.

Flywheel 114 has the ability to catch gearing and drive alternator (or generator) 118 to produce ride-through power for the load. In a preferred embodiment, the gearing that flywheel 114 catches is drive gears 134 which interconnect with drive gears 140 driving alternator 118. In such an embodiment, alternator 118 may also be located inside the cylinder of flywheel 114. Additionally, when the ride-through power is not needed, alternator 118 may supply power in reverse, causing drive gears 140 to rotate drive gears 134 and assist in spinning flywheel 114 up to speed. In this embodiment, after the flywheel is brought up to speed, the minimum energy needed to maintain that speed can be supplied by water turbine 116.

FIG. 4 illustrates water turbine 116 without the outer-encasement, in accordance with an embodiment of the present invention. Tubing 142 receives water at the top of water turbine 116. Tubing 142 wraps around a water driven propeller system (not shown) to convert the kinetic energy into torque. Tubing 142 is open towards the center to allow water to be diverted onto the propeller system. After water has made its way through the propeller system, the water exits tubing 142 near the bottom of water turbine 116. In a preferred embodiment, tubing 142 maintains a diameter equal to piping 120 (so no pressure is lost) and wraps around the propeller system at least once to make the most use out of the propeller blades.

As previously discussed, water turbine 116 is preferably a reaction turbine. Exemplary designs for reaction turbines include Kaplan, Francis, Propeller, Bulb, Tyson, etc. Kaplan turbines work well for high-flow, low-head applications (head describes the distance that a given water source has to fall before the point where power is generated) which make them ideal for the water-driven flywheel UPS.

FIG. 5 depicts the working of a Kaplan turbine in accordance with an embodiment of the invention.

As noted previously, tubing 142 is open along its inner side to allow water to be diverted. Tubing 142 wraps around wicket gate 144. Wicket gate 144 comprises a number of angled barriers 146 to direct the water tangentially through wicket gate 144. This causes the water to spiral on to propeller blades 148 causing the propeller to spin. The propeller is attached to turbine shaft 128.

FIG. 6 depicts an embodiment of planetary gear 130. Planetary gear 130 comprises three outer gears 150 (planet gears) revolving around a center gear 152 (sun gear). In other embodiments, planetary gear 130 may have any number of outer gears. Annulus 154 surrounds and meshes with outer gears 150.

Outer gears 150 are tied together by carrier 156. Turbine shaft 128 connects with carrier 156 so, with annulus 154 held stationary, as turbine shaft 128 rotates, outer gears 150 rotate around center gear 152, causing center gear 152 to rotate (in the opposite direction) at a ratio of 1+Na/Nc where Na is the number of teeth on annulus 154 and Nc is the number of teeth on center gear 152. Center gear 152 connects to output shaft 132.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

Having described preferred embodiments of a water-driven flywheel UPS (which are intended to be illustrative and not limiting), it is noted that modifications and variations may be made by persons skilled in the art in light of the above teachings. It is therefore to be understood that changes may be made in the particular embodiments disclosed which are within the scope of the invention as outlined by the appended claims.

What is claimed is:

1. An uninterruptible power supply (UPS) for providing electrical power to one or more computers, the UPS comprising:
a turbine;
an intake tube that is capable of channeling moving fluid to the turbine;
an output tube that is capable of channeling moving fluid from the turbine;
a flywheel for driving a generator capable of providing electrical power to the one or more computers; and
a turbine shaft coupled to the turbine and to the flywheel, the turbine shaft capable of being driven by the turbine and of driving the flywheel.

2. The UPS of claim 1, further comprising the generator.

3. The UPS of claim 1, wherein the UPS is rack-mountable.

4. The UPS of claim 1, wherein the turbine is a reaction turbine.

5. The UPS of claim 1, further comprising planetary gearing, wherein an input of the planetary gearing is coupled to the turbine shaft and an output of the planetary gearing is capable of driving the flywheel at a rotational velocity greater than a rotational velocity of the turbine shaft.

6. The UPS of claim 1, wherein the flywheel comprises a hollow cylinder.

7. The UPS of claim 6, wherein the turbine is centered within a perimeter of the hollow cylinder.

8. The UPS of claim 7, wherein the generator is within the perimeter of the hollow cylinder.

9. The UPS of claim 1, wherein the flywheel comprises a disk.

10. The UPS of claim 2, wherein the generator is capable of receiving electrical power from an outside source and, when not being driven by the flywheel, of rotating the flywheel.

11. A system for providing power to one or more computers, the system comprising:
a generator coupled to the one or more computers;
a flywheel coupled to and capable of driving the generator;
an uninterruptible power supply (UPS) comprising a fluid-driven turbine coupled to and capable of driving the flywheel;
a server rack containing the UPS and at least one of the one or more computers;
a liquid-cooling system coupled to the UPS and capable of pushing a fluid to the server rack and to the fluid-driven turbine of the UPS; and
wherein the generator, when driven by the flywheel, is capable of providing electrical power to the one or more computers.

12. The system of claim 11, wherein the liquid-cooling system comprises a mechanical pump for pushing the fluid.

13. The system of claim 11, wherein the liquid-cooling system comprises a reservoir of the fluid elevated above the UPS so that in response to a trigger, a catch is released and the fluid is pulled into the fluid-driven turbine of the UPS via a gravitational force.

14. The system of claim 13, wherein the trigger is the failure of a mechanical pump.

15. A method for powering a computer, the method comprising the steps of:
an uninterruptible power supply (UPS) receiving a fluid;
the UPS channeling the fluid to a reaction turbine via an intake tube;
the reaction turbine rotating a turbine shaft;
the rotating turbine shaft driving a flywheel coupled to the rotating turbine shaft and a generator; and
in response to the computer losing electrical power, the flywheel driving the generator and the flywheel-driven generator supplying electrical power to the computer system.

16. The method of claim 15, further comprising the UPS channeling the fluid, as the fluid leaves the reaction turbine, to the computer.

17. The method of claim 15, further comprising a mechanical pump pushing the fluid from a liquid cooling system to the UPS.

18. The method of claim 15, further comprising a liquid cooling system releasing a catch to allow the fluid to flow to the UPS, via gravitational force, from an elevated reservoir.
